(19) United States
(12) Patent Application Publication
(10) Pub. No.: US 2024/0289704 A1
(43) Pub. Date: Aug. 29, 2024

(54) METHODS, APPARATUSES, DEVICE AND MEDIUM FOR INFORMATION PROCESSING

(71) Applicant: Beijing Zitiao Network Technology Co., Ltd., Beijing (CN)

(72) Inventors: Yiming Kang, Beijing (CN); Gang Li, Beijing (CN); Sisi Pan, Beijing (CN); Bixing Sheng, Beijing (CN); Han Deng, Beijing (CN); Jun Liu, Beijing (CN); Zexian Xie, Beijing (CN); Qing Bai, Beijing (CN); Gaolu Li, Beijing (CN); Xiang Zou, Beijing (CN)

(21) Appl. No.: 18/569,732

(22) PCT Filed: Aug. 18, 2022
(86) PCT No.: PCT/CN2022/113333

§ 371 Date: Dec. 13, 2023

(30) Foreign Application Priority Data
Aug. 18, 2021 (CN) 202110949675.0

(51) Int. Cl. G06Q 10/0631; G06F 9/451; G06F 40/186; G06Q 10/101

(52) U.S. Cl. CPC G06Q 10/06311; G06F 9/453; G06F 40/186; G06Q 10/06316; G06Q 10/101

(57) ABSTRACT

Embodiments of the disclosure relate to a method, apparatus, device, and medium for information processing, wherein the method includes: in response to a trigger operation for a workflow type, displaying an editing page comprising a workflow identification and/or a workflow content, and the workflow content comprising a document, the document being a co-operable shared document; receiving, on the editing page, an edited content input by a predetermined user; and in response to a submission instruction for the workflow type, transmitting a corresponding workflow to a first user. Therefore, the application of collaboration of a plurality of parties in the workflow enhances the degree of automation and efficiency of workflow processing and satisfies the needs of a plurality of parties to interact in workflow processing.

### CROSS REFERENCE

The present application claims priority to Chinese Patent Application No. 202110949675.0 filed on Aug. 18, 2021, and entitled “METHOD, APPARATUS, DEVICE AND MEDIUM FOR INFORMATION PROCESSING”, the entirety of which is incorporated herein by reference.

### FIELD

The present disclosure relates to the technical field of computers, for example, to a method, apparatus, device and medium for information processing.

### BACKGROUND

With the development of computer technology, online workflow has become a more common way of working because it does not require users to write documents personally.

In related technologies, online workflow is mainly processed by users writing work contents in the corresponding application, and then transmitting the work contents online to the corresponding audit objects.

However, the above-mentioned way of transmitting work only implements online transmitting, but the experience of writing work content is poor, and it is impossible to achieve a collaboration of a plurality of people, which leads to the low efficiency of workflow processing.

### SUMMARY

In order to solve or at least partially solve the above technical problems, the present disclosure provides a method, apparatus, device and medium for information processing.

Embodiments of the present disclosure provide a method of information processing, the method comprising: in response to a trigger operation for a workflow type, displaying an editing page comprising a workflow identification and/or a workflow content, and the workflow content comprising a document, the document being a co-operable shared document; receiving, on the editing page, an edited content input by a predetermined user; and in response to a submission instruction for the workflow type, transmitting a corresponding workflow to a first user.

Embodiments of the present disclosure provide a method of information processing, the method comprising: in response to a trigger operation for a workflow by a first user, displaying an editing page of the workflow, the editing page comprising a document, the document being a co-operable shared document; receiving content information input via the editing page; and in response to a submission operation for the workflow, transmitting a corresponding workflow to a second user.

Embodiments of the present disclosure provide a method of information processing, the method comprising: displaying a workflow state list; and in response to a trigger operation for a workflow by a second user, displaying content information of the workflow, wherein the content information comprises a document, the document being a co-operable shared document.

Embodiments of the present disclosure further provide an apparatus for information processing, the apparatus comprising: a first display module configured to, in response to a trigger operation for a workflow type, displaying an editing page comprising a workflow identification and/or a workflow content, and the workflow content comprising a document, the document being a co-operable shared document; a first reception module configured to receive, on the editing page, an edited content input by a predetermined user; and a first transmitting module configured to, in response to a committing instruction for the workflow type, transmit a corresponding workflow to a first user.

Embodiments of the present disclosure further provide an apparatus for information processing, the apparatus comprising: a fourth display module configured to, in response to a trigger operation for a workflow by a first user, display an editing page of the workflow, the editing page comprising a document, the document being a co-operable shared document; a second reception module configured to receive content information input via the editing page; and a second transmitting module configured to, in response to a committing operation for the workflow, transmit a corresponding workflow to a second user.

Embodiments of the present disclosure further provide an apparatus for information processing, the apparatus comprising: a sixth display module configured to display a workflow state list; and a seventh display module configured to, in response to a trigger operation for a workflow by a second user, display content information of the workflow, wherein the content information comprises a document, the document being a co-operable shared document.

Embodiments of the present disclosure further provide an electronic device, the electronic device comprising: a processor; and a memory storing instructions executable for the processor; the processor configured to read the executable instructions from the memory and execute the instructions to implement the method of information processing provided by embodiments of the present disclosure.

Embodiments of the present disclosure further provide a computer-readable storage medium, the medium storing a computer program, the computer program, when executed by a computer device, causing the computer device to perform the method of information processing provided by embodiments of the present disclosure method.

The technical solutions provided by embodiments of the present disclosure have the advantages over the prior art: the solution of information processing provided by embodiments of the present comprises, in response to a trigger operation for a workflow type, displaying an editing page comprising a workflow identification and/or a workflow content, and the workflow content comprising a document, the document being a co-operable shared document; receiving, on the editing page, an edited content input by a predetermined user; and in response to a submission instruction for the workflow type, transmitting a corresponding workflow to a first user; in response to a trigger operation for a workflow by a first user, displaying an editing page of the workflow, the editing page comprising a document, the document being a co-operable shared document; receiving content information input via the editing page; and in response to a submission operation for the workflow, transmitting a corresponding workflow to a second user; then, displaying a workflow state list for a second user; and in response to a trigger operation for a workflow by the second user, displaying content information of the workflow, wherein the content information comprises a document, the document being a co-operable shared document. As a result, the application of collaboration of a plurality of parties in the workflow enhances the degree of automation and efficiency of workflow processing and satisfies the needs of a plurality of parties to interact in workflow processing.

### BRIEF DESCRIPTION OF THE DRAWINGS

In conjunction with the accompanying drawings and with reference to the following detailed description, the above and other features, advantages, and aspects of the various embodiments of the present disclosure will become more obvious. Throughout the accompanying drawings, the same or similar drawing labels indicate the same or similar elements. It should be understood that the accompanying drawings are schematic and that the originals and elements are not necessarily drawn to scale.

FIG. 1 is a schematic diagram of a scene of information processing provided by embodiments of the present disclosure;

FIG. 2 is a schematic diagram of another scene of information processing provided by embodiments of the present disclosure;

FIG. 3 is a flowchart of a method of information processing according to one embodiment of the present disclosure;

FIG. 4 is a schematic diagram of another scene of information processing provided by embodiments of the present disclosure;

FIG. 5 is a schematic diagram of a scene of an editing page according to an embodiment of the present disclosure;

FIG. 6 is a schematic diagram of a scene of an editing page according to another embodiment of the present disclosure;

FIG. 7 is a schematic diagram of a scene of an editing page according to another embodiment of the present disclosure;

FIG. 8 is a flowchart of a method of information processing according to another embodiment of the present disclosure;

FIG. 9 is a schematic diagram of a scene of information processing according to another embodiment of the present disclosure;

FIG. 10 is a schematic diagram of a scene of information processing according to another embodiment of the present disclosure;

FIG. 11 is a schematic diagram of a scene of information processing according to another embodiment of the present disclosure;

FIG. 12 is a schematic diagram of a scene of information processing according to another embodiment of the present disclosure;

FIG. 13 is a schematic diagram of a scene of information processing according to another embodiment of the present disclosure;

FIG. 14 is a flowchart of a method of information processing according to another embodiment of the present disclosure;

FIG. 15 is a schematic diagram of a scene of information processing according to another embodiment of the present disclosure;

FIG. 16 is a schematic diagram of a scene of information processing according to another embodiment of the present disclosure;

FIG. 17 is a schematic diagram of a scene of information processing according to another embodiment of the present disclosure;

FIG. 18 is a schematic diagram of a scene of information processing according to another embodiment of the present disclosure;

FIG. 19 is a schematic diagram of a scene of information processing according to another embodiment of the present disclosure;

FIG. 20 is a structural schematic diagram of an apparatus for information processing provided by embodiments of the present disclosure;

FIG. 21 is a structural schematic diagram of another apparatus for information processing provided by embodiments of the present disclosure;

FIG. 22 is a structural schematic diagram of another apparatus for information processing provided by embodiments of the present disclosure; and

FIG. 23 is a structural schematic diagram of an electronic device provided by embodiments of the present disclosure.

### DETAILED DESCRIPTION

Embodiments of the present disclosure will be described below with reference to the accompanying drawings. Although some embodiments of the present disclosure are shown in the accompanying drawings, however, the present disclosure can be implemented in a variety of forms, and these embodiments are provided for the purpose of understanding the present disclosure. The accompanying drawings and embodiments of the present disclosure are intended to be exemplary only.

It should be understood that the plurality of steps documented in the method embodiments of the present disclosure may be performed in a different order, and/or in parallel. In addition, the method embodiments may comprise additional steps and/or omit performing the illustrated steps. The scope of the present disclosure is not limited in this regard.

As used herein, the term “comprises” and its variations are open-ended, i.e., “comprising, but not limited to”. The term “based on” is “based at least partially on”. The term “one embodiment” represents “at least one embodiment”; the term “another embodiment” represents “at least one additional embodiment”; the term “some embodiments” represents “at least some embodiments”. Related definitions of other terms will be given in the description below.

It should be noted that references to the concepts of “first”, “second” and the like in the present disclosure are only used to distinguish different apparatuses, modules, or units, and are not intended to limit the order or interdependence of the functions performed by these apparatuses, modules, or units.

It should be noted that references to the qualifications “one” and “a plurality of” in the present disclosure are schematic rather than limiting. It should be understood by those skilled in the art that the term “one or more” should be understood unless the context clearly indicates otherwise.

The names of the messages or information interacted with between the plurality of apparatuses of the embodiments of the present disclosure are used for illustrative purposes only and are not intended to place limitations on the scope of those messages or information.

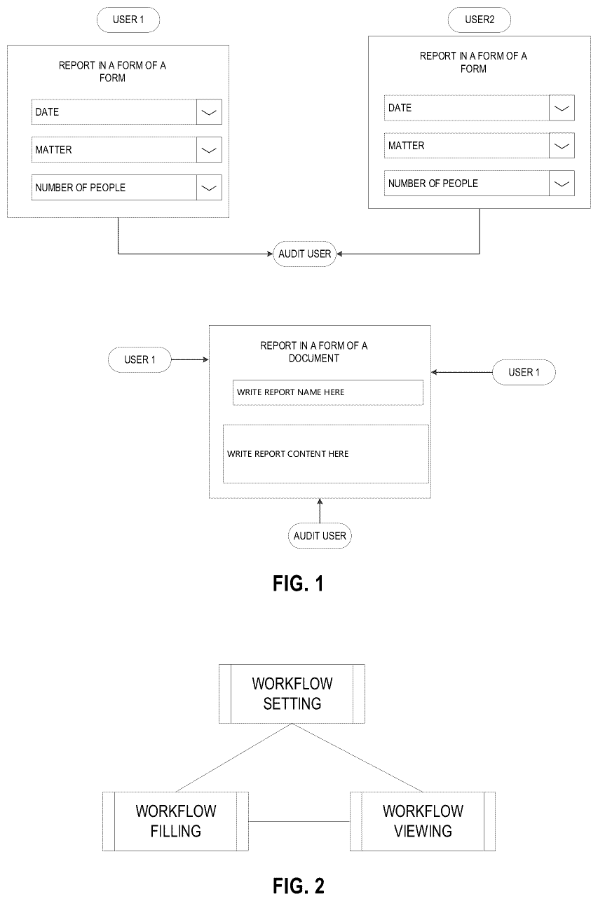

In order to solve the above problems, embodiments of the present disclosure provide a method of information processing. In this method, an automated process from writing to transmitting to audit is provided in the workflow, which improves the efficiency of the workflow, and, in order to improve the flexibility of processing the workflow, the workflow in the present embodiment includes a document form. As shown in FIG. 1, the workflow in the form of a document is more flexible in terms of writing content than the workflow in the form of a form and can satisfy the online collaboration editing of a plurality of users, satisfying the need for interactions of the plurality of users in processing the workflow, and the method is introduced in the following with a specific implementation example. The workflows in the present embodiment comprise, but are not limited to, approval workflows, report workflows, and other online processing work contents.

Since in the actual performing process, as shown in FIG. 2, during information processing, it involves the setting end of the document corresponding to the workflow, the filling end of the document and the audit end of the document, for the sake of convenience of description, the subsequent embodiments will focus on the setting end, the filling end and the audit end to perform the description of the information processing method respectively. Herein, it should be noted that the method of information processing described in the following embodiments can be applied to the mobile terminal or the PC terminal with the same application logic, but in order to adapt to the operating system of the mobile terminal or the PC terminal, there are differences in the display of the corresponding pages, so for the sake of convenience of illustration, the following embodiments illustrate the corresponding embodiments with examples of only one of the operating systems.

The following description concentrates first on the setting end.

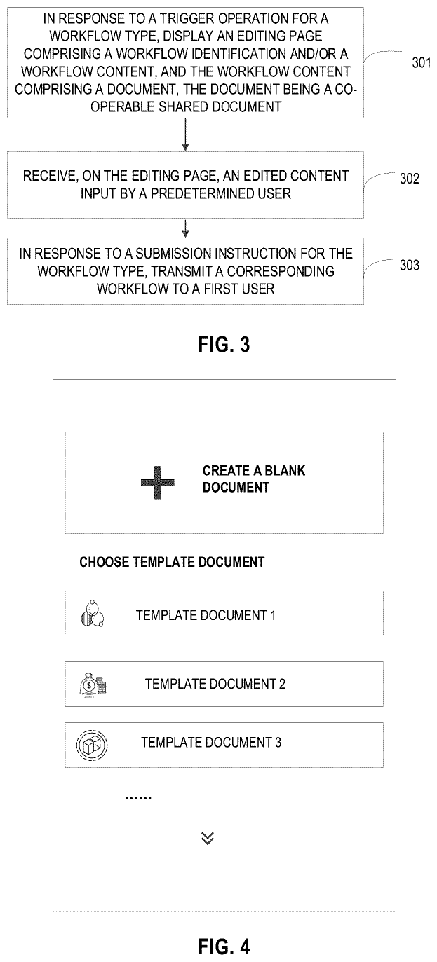

FIG. 3 is a flowchart of a method of information processing according to one embodiment of the present disclosure. As shown in FIG. 3, the method comprises:

Step 301. In response to a trigger operation for a workflow type, display an editing page comprising a workflow identification and/or a workflow content, and the workflow content comprising a document, the document being a co-operable shared document.

In the present embodiment, in response to a trigger operation for a workflow type, display an editing page comprising a workflow identification and/or a workflow content, and the workflow content comprising a document, the document being a co-operable shared document. Herein, the workflow identification can be the name of the workflow or the identification name of the corresponding document.

In some possible embodiments, the editing page, the editable document may be part or all of the workflow, in the present embodiment, in response to a trigger operation for a first workflow type, display an editable document page, or, in response to a trigger operation for a second workflow type, display an editable document page and a further predetermined and non-editable workflow content. In the present embodiment, trigger controls may be predetermined corresponding to different types of work, in order to facilitate user settings. The trigger control may be implemented for any combination of text, icons, layers, colors, etc., in order to intuitively display different types of workflow type control, this is not limited herein.

In embodiments of the present disclosure, when setting the document in the workflow, the document type may be various, for example, a new empty document type, selecting template document type, and so on.

In the present embodiment, in response to a trigger operation for a new document, display a customizable editable document page, in order to satisfy personalized needs of the user for the workflow; further in response to a trigger operation for the template document control, display an editable template document page.

Herein, the template document can be predetermined by the system or generated based on the historical setting of the user. The template document can comprise commonly used scenes such as work weekly reports, daily meetings, and daily health reports.

In accordance with a determination that a trigger operation is performed on the new document control, for ease of setting up, different types of document types and using scenes can be introduced on a selection page by video (or image), literature, etc. If the trigger operation is performed on a template document control, it will skip this step and default to the selection of a previous history document or a predetermined document.

For example, as shown in FIG. 4, in response to a trigger operation for a shared document, display corresponding new document controls, template document controls, and the like on the relevant operation interface, wherein there can be a plurality of template document controls, and the plurality of template document controls can correspond to documents of history setting.

In the actual display of the document, in response to an expanding operation for the document, display an entire content of the document on the editing page; or in response to a folding operation for the document, displaying, on the editing page, indication information representing the content of the document. The indication information can be in the form of text or video images, etc. In addition, the expanding operation and folding operation can be implemented by corresponding controls, speech, or gesture operations, etc.

Step 302. Receive, on the editing page, an edited content input by a predetermined user.

In the present embodiment, due to the consideration of the different work requirements of users for different workflows, therefore, in order to satisfy the individualization of work requirements, receive, on the editing page, an edited content input by a predetermined user.

Herein, the edited content is used to indicate the content of the workflow of the corresponding shared document, and/or the submission rules of the workflow, and the like. The submission rules comprise, but are not limited to, rules relating to submission time, rules relating to submission audit, and the like.

With respect to the content of the workflow, in an embodiment of the present disclosure, receiving, on the editing page, guidance information input by a predetermined user for instructing the first user to edit content of the document, wherein the first user may be understood to be a user who has the permission to fill out the content of the shared document, e.g., when the shared document is a report document, the corresponding first user may comprise a user who fills out a report, and the like.

The guidance information in the present embodiment can be used to inform the first user of what content should be set in the shared document area, for example, for the report title of the report workflow, the corresponding guidance information can comprise the word limit of the report name, the report name filling rules, etc. Herein, the guidance information can be text or icons, for example, the guidance information is displayed in the corresponding to-be-filled content area, or it can be displayed in the vicinity of the to-be-filled content area, and it can further be in the form of a floating icon. In accordance with a clicking by the user on the corresponding icon, the corresponding guidance information is displayed in the form of a floating window.

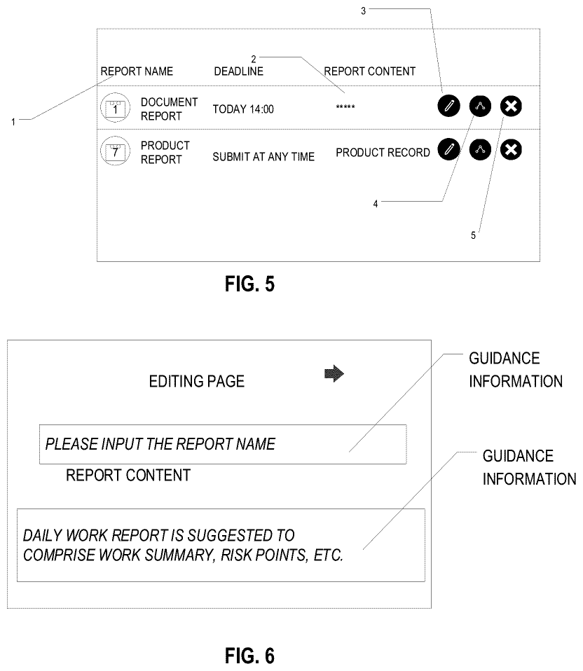

In some embodiments, the predetermined target template guidance information may be displayed on the editing page, and the guidance information displayed to the first user may be determined based on confirmation operation and/or modification operation by the predetermined user for the target template guidance information. Or customizable editing prompt information may further be displayed on the editing page to receive customizable guidance information input via the editing page. For example, as shown in FIG. 5, when the workflow scene is a report scene, the target template guidance information is the text part shown in FIG. 1 and FIG. 2. Based on the text part shown in FIG. 1 and FIG. 2, the corresponding text content can be modified, such as modifying the target template guidance information in the document content. FIG. 3-FIG. 5 indicate the target guidance information in the form of icons, and “Editing”, “Sharing”, and “Deleting” functions can be provided according to the corresponding icons, etc., and the guidance information displayed to the first user can be added or modified by using the icons in FIG. 3-FIG. 5.

For example, as shown in FIG. 6, when the first user fills in the corresponding workflow in a form of report, the guidance information corresponding to the report name and report content can be seen in the document in text form, and the first user can fill in the content of the shared document based on the template guidance information.

In terms of rules of submission time, in one embodiment of the present disclosure, receiving, on the editing page, a first user identification and a committing time input by a predetermined user, wherein the first user identification may be a username, user phone number, user registration account, etc., the submission time may be a submitted period of the workflow and the like.

In the present embodiment, in order to facilitate the first user to fill in the workflow in time, it can further receive, on the editing page, a reminder time input by a predetermined user, and further, transmit a reminder message of the workflow to the first user based on the reminder time.

In terms of rules of submission audit, in one embodiment of the present disclosure, receiving, on the editing page, a second user identification input by the predetermined user, wherein the second user may comprise a shared document auditor and/or CC and the like.

In the present embodiment, in response to a committing instruction for the workflow by the first user, transmit an audit message of the workflow to a second user based on the second user identification, so that the second user can audit the corresponding workflow in time.

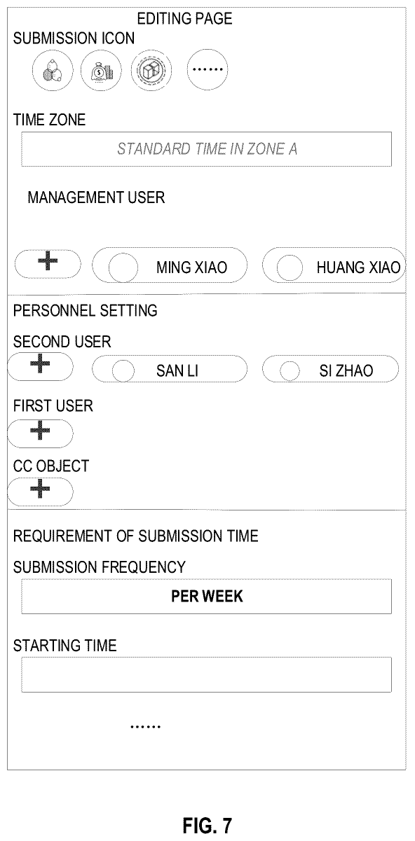

In other words, the editing page can receive any customization settings from the predetermined users of the workflow to satisfy the customization needs of the workflow. As a possible implementation, when the workflow scene is a report scenario, report filling period, report icon, report start date and deadline date, report submission method, report reminder message (automatic reminder period, etc.), report submission period, and so on, and further the time period for report in respective report period, the report target (i.e., to whom the report is transmitted to, the user to whom the report is copied, etc.), and so on, can be filled in the editing page. A possible editing page is shown in FIG. 7.

Step 303. In response to a submission instruction for the workflow type, transmit a corresponding workflow to a first user.

In the present embodiment, in order to facilitate the first user to fill in the corresponding workflow, in response to a submission instruction for the workflow type, the workflow is transmitted to the first user.

In one embodiment of the present disclosure, in accordance with a determination that a first user identification and submission time are predetermined in the editing page, in response to the submission instruction for the workflow type, the workflow can be submitted to the corresponding first user based on to the submission time and the first user identification.

In the present embodiment, since the workflow comprises a shared document. Therefore, shared documents can be edited in collaboration by a plurality of users, thus improving the efficiency of workflow processing. For example, in a report workflow scene, the plurality of first users collaborate to fill in the shared document in the workflow. As a result, there is no need for the plurality of first users to transmit the report information respectively, and there is no need to manually edit and summarize the report information of the plurality of first users, and the corresponding summarized results are directly obtained, which improves the processing efficiency of the workflow.

As mentioned above, the workflow can be all documents or part of documents. Therefore, in order to facilitate management, in one embodiment of the present disclosure, in response to a submission instruction for a workflow the document is established in a document space of a user associated with the workflow type. The document space includes documents in the workflow related to the associated user, so that workflows and documents in workflows can be processed separately. Or in response to the trigger operation for the workflow type, the document is established in a document space of a user associated with the workflow type. Therefore, the separate management of documents in the workflow is implemented based on the document space, which improves the refinement of the workflow processing.

Readily understood, in order to facilitate the management of the document, in the present embodiment, in response to an editing operation for the document in the document space, a synchronous update of an edited content is applied into the document of the workflow content. As a result, synchronization of documents in the document space and documents displayed in the workflow is implemented.

In addition to segregating workflows and documents in the management space, in an embodiment of the present disclosure, workflows and documents may further be segregated in the service reminder. For example, in one embodiment of the present disclosure, in response to the submitting instruction for the workflow type or in response to the trigger operation for the workflow type, a user identity corresponding to the workflow type can be created. The user identity corresponding to the workflow type can be a real pre-registered user identity or a system virtual user identity assigned to the enterprise user corresponding to the workflow type, which is not limited here.

In the actual performing process, the user identity can provide relevant reminder services to the first user and second user to improve user interaction and facilitate the stickiness of users and products.

In summary, method of information processing provided by embodiments of the present disclosure, in response to a trigger operation for a workflow type, display an editing page comprising a workflow identification and/or a workflow content, and the workflow content comprising a document, the document being a co-operable shared document; receive, on the editing page, an edited content input by a predetermined user; and in response to a submitting instruction for the workflow type, transmit a corresponding workflow to a first user. Therefore, document editable in collaboration with a plurality of parties can be applied in the workflow, which improves the automation and efficiency of workflow processing and satisfies the need for a plurality of interaction in workflow processing.

Next, the following description concentrates on the filling end.

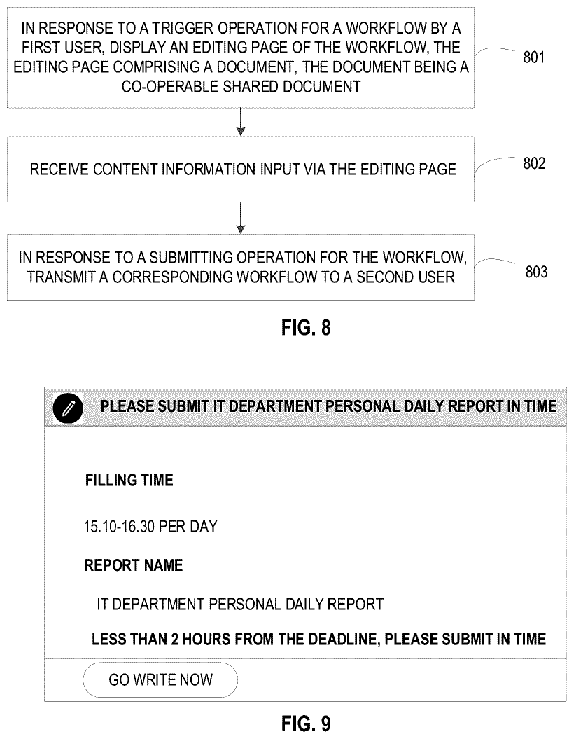

FIG. 8 is a flowchart of a method of information processing according to another embodiment of the present disclosure. As shown in FIG. 8, the method comprises:

Step 801. In response to a trigger operation for a workflow by a first user, display an editing page of the workflow, the editing page comprising a document, the document being a co-operable shared document.

In the present embodiment, as mentioned above, the editing page comprises: an editable document page; or the editing page comprises: an editable document page and a further predetermined and non-editable workflow content, and the non-editable other workflow content may comprise predetermined annotated information such as names, entries, and the like of the relevant content to facilitate review of the workflow, and the like. The editing page is an editing page of the workflow displayed by the user with the management identity of the workflow based on the predetermined content of the workflow. The management identity user can be the predetermined user described above, or a system virtual user of the workflow application. When it is a system virtual user, the system generates a corresponding editing page based on the content edited by the predetermined user on the editing page and the predetermined workflow page generation framework, etc.

In addition, the editable document page comprises: a customizable editable document page; or an editable template document page, wherein the first user has an edit permission for the document page.

In the present embodiment, in response to a trigger operation for a workflow by a first user, display an editing page of the workflow, the editing page comprising a document, the document being a co-operable shared document.

In practical applications, in response to a trigger operation for a workflow by a first user, display an editing page of the workflow, the editing page comprising a document, the document being a co-operable shared document, or, in response to a folding operation for the document, display, on the editing page, indication information representing the content of the document.

In an embodiment of the present disclosure, in order to facilitate the first user to fill in the workflow in time, a reminder message of the workflow is transmitted to the first user based on a reminder time set by a predetermined user and the like, to thereby receive a reminder message of the workflow, wherein the reminder message comprises a link entry of the workflow. In response to a trigger operation for the link entry, the editing page of the workflow is displayed. It should be noted that the editing page here may not be exactly the same as the type of the editing page of the predetermined user, and the page displayed is the one that the first user has permission to edit. For example, for the predetermined user, the editing page displayed comprises a setting page for editing rules, but for the first user, it may only include a content filling and editing page.

For example, the first user can be reminded of the workflow to-be-processed in the corresponding workflow application in the form of a reminder message that displays the elements consistent with the form report. For example, for a report workflow, as shown in FIG. 9, the notification title is “Please submit in time+Report Rule Name”, “Filling time”, “Report name”, “Report object”, “Less than X hours from the deadline, please submit in time” and other reminder content, and link entries such as “Go Write Now”, etc.

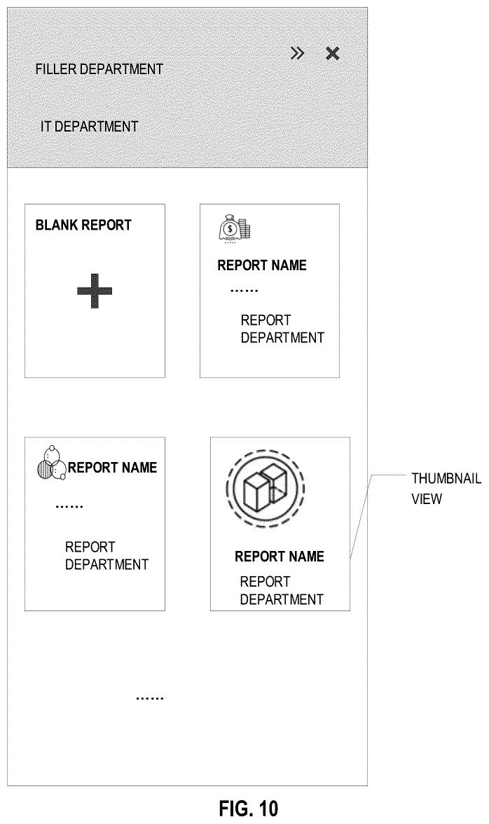

In the present embodiment, when displaying the editing page of the workflow, view information of a workflow to-be-processed may be displayed in the corresponding report application. The view information may be a thumbnail, text, an image in a non-thumbnailed form, etc., and in response to a trigger operation for the view information, the editing page of the workflow is displayed, wherein, when the view information is a thumbnail and the workflow is a report workflow as shown in FIG. 10, the thumbnail view may comprise guidance information of the report name, the report content waiting to be filled in, and the first user may fill in the workflow based on the guidance and the information.

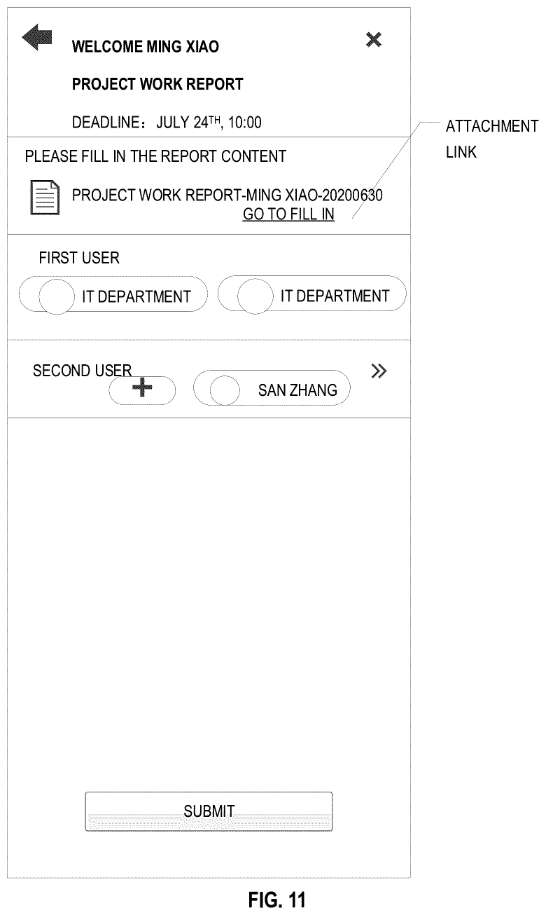

In the present embodiment, the editing page can directly display the editing area of the shared document and can further display the attachment link entry of the shared document. For example, as shown in FIG. 11, when the workflow is report, the attachment link corresponding to the shared document can be displayed on the corresponding editing page. The attachment link corresponding to the attachment can be the corresponding shared document filled in by the first user last time, so that the first user can complete the filling of the shared document by modifying the content on the basis of the last shared document. If the corresponding contribution document is filled in for the first time, the attachment link can correspond to the document edited by the predetermined user. In the present embodiment, the first user can click “submit” on the corresponding editing page only after the first user has completed filling in the document, and when the first user does not fill in the corresponding shared document i.e., clicks “submit”, the submission will be rejected and the feedback submission failure message will be displayed in a pop-up window or the like, and so on.

Step 802. Receive content information input via the editing page.

In the present embodiment, receiving content information input via the editing page, the content information may be understood as content filled by the first user on the editing page and the like.

The permission settings of the workflow here are the same as those of administrator of the first user for the document to ensure compliance with the application scene requirements corresponding to the workflow.

Step 803. In response to a submitting operation for the workflow, transmit a corresponding workflow to a second user.

In the present embodiment, in response to a submitting operation for the workflow, a corresponding workflow is transmitted to a second user, so that the second user can audit the workflow and the like. Herein, the workflow can be transmitted to the second user by a management identity user of the workflow or a first document virtual user. The first virtual user is a virtual user such as a virtual service assistant provided by the workflow application for the enterprise or individual corresponding to the workflow, or a predetermined real user with management permissions, and the management identity user can be a predetermined real user with management permissions.

In an embodiment of the present disclosure, in order to improve a sense of interaction with the first user, after submitting a workflow, in response to the submission operation of the workflow, a submission processing result notification is displayed. The submission processing result notification may be fed back to the first user in the form of a conversation message, or it may be displayed in the form of a to-be-processed matter in a corresponding functional area, etc., and the submission processing result notification comprises an audit result and the like. When there is a plurality of the second user audited, it may also comprise the number of the second user that has been deliberated, etc.

Obviously, in the present embodiment, a predetermined second user associated with the workflow is further obtained, the second user may be predetermined when generating the corresponding workflow or may be specified in real time by the first user when editing the corresponding second user, as shown in FIG. 11. Further, a viewing notification message of the workflow is transmitted to the second user, so that the second user can view the corresponding workflow based on the viewing notification message. Herein, when transmitting the workflow to the corresponding second user, the document viewing permission is automatically activated for the second user.

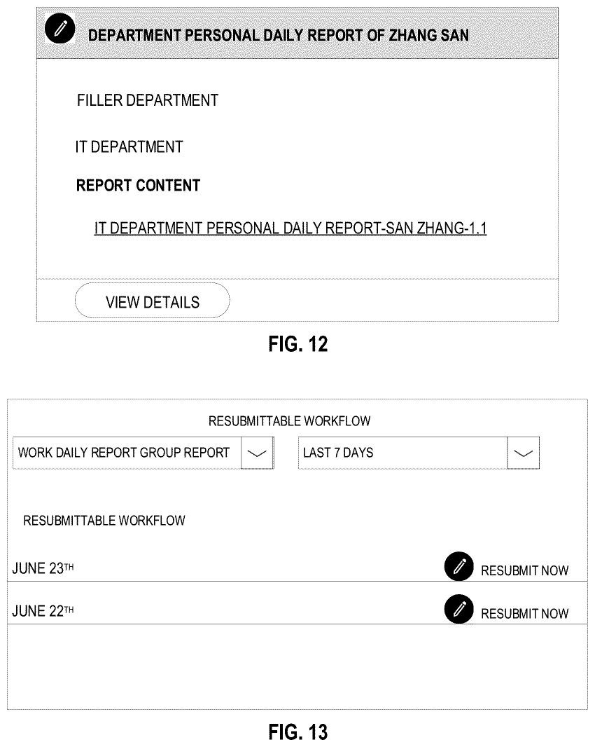

Herein, in the actual performing process, as shown in FIG. 12, when the workflow is report, the viewing notification message may comprise: Filler Name, Report Name (e.g. [Filler Name]+“of”+[Report Name]), Filler Department, Report Content, Document Link (e.g., a hyperlink to a document with the name of the document), or a control for viewing details. For example, the user can click on the document hyperlink or the view details control to open the corresponding workflow using the default browser of the report object, and so on.

In the present embodiment, for ease of management, in response to a trigger operation for a workflow by a first user, the document is created by a user identity corresponding to the workflow, i.e., for ease of subsequent management, it is created by a predetermined user identity corresponding to a first user in the workflow. For example, for a first user in the address book workflow, using the identity of the first user in the address book group to create a document, in order to be informed of the source user of the edited content of a shared document in a workflow.

Similarly, in the present embodiment, the document is associated with the document space, performing the file is separately in the document space, and the document control belongs to the user associated with the workflow. The associated user may comprise a first user, a second user, and a predetermined user, and other related users, the associated user corresponding to the document space can perform separate editing, filling, and other processing on the document in the workflow, which can be synchronized to the workflow. For example, when the first user edits the shared document in the workflow, the shared document in the workflow is applied with a synchronous update.

In the present embodiment, notification information of the workflow is transmitted to the first user by a management identity user of the workflow or a first document virtual user. Herein, the notification message comprises but is not limited to filling notification, permission changing, audit notification, etc., wherein the management identity user of the workflow or a first document virtual user is a service user related to the workflow. As mentioned above, the workflow and the management of the shared document are segregated for ease of management, therefore, when the notification service is provided, the service user associated with the shared document, i.e., the second virtual user, may also transmit the notification message of the workflow to the first user. The second virtual user may be a virtual service user associated with the document space or may be a predetermined real administrative user. For ease of differentiation, in some possible embodiments, the username of the first virtual user may be “workflow assistant” and the username of the second virtual user may be “shared document assistant”.

Therefore, in the present embodiment, in order to avoid disturbing the user, in response to transmitting notification information of the workflow to the first user by the first document virtual user, a second document virtual user is disabled from transmitting notification information of the workflow to the first user. Certainly, it is also possible to, in response to transmitting notification information of the workflow to the first user by the second document virtual user, a first document virtual user is disabled from transmitting notification information of the workflow to the first user.

In the actual performing process, when the first user misses the specified submission time, the corresponding workflow can also be resubmitted in the form of resubmission, clicking on the “Resubmit Now” control, jumping across to the corresponding workflow submission page, and then resubmitting the relevant workflow in the workflow submission page. Herein, the workflow that can be resubmitted in the workflow submission page is determined based on setting information. For example, the workflow that has not exceeded the specified resubmission period from the current time is the workflow that can be resubmitted. Herein, as shown in FIG. 13, when there is a plurality of resubmittable workflows, the resubmittable workflows can be displayed in the form of a list.

In summary, the method of information processing provided by embodiments of the present disclosure, in response to a trigger operation for a workflow by a first user, display an editing page of the workflow, the editing page comprising a document, the document being a co-operable shared document; receive content information input via the editing page; and in response to a submitting operation for the workflow, transmit a corresponding workflow to a second user. Therefore, document editable in collaboration with a plurality of parties can be applied in the workflow, which improves the automation and efficiency of workflow processing and satisfies the need for a plurality of interaction in workflow processing.

Finally, the following description concentrates on the audit end.

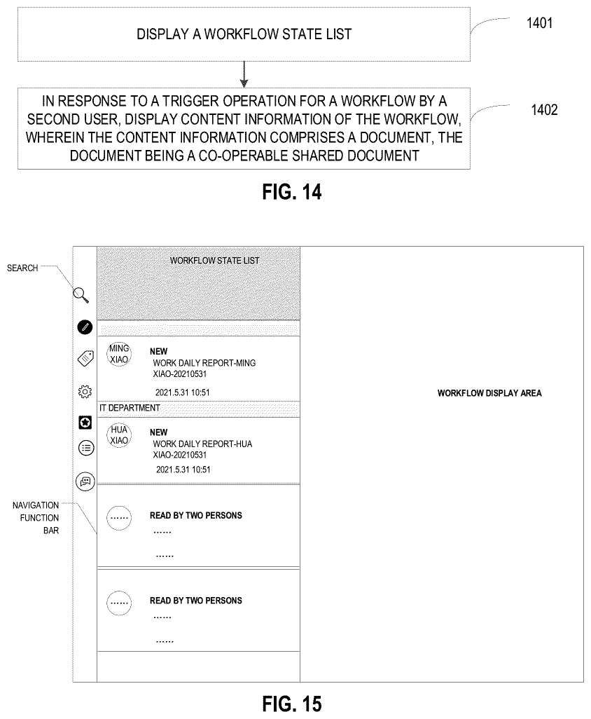

FIG. 14 is a flowchart of a method of information processing according to another embodiment of the present disclosure. As shown in FIG. 14, the method comprises:

Step 1401. Display a workflow state list.

In the present embodiment, the workflow to-be-viewed is displayed in the form of a list. In some possible implementations, the workflow state list comprises a workflow identification and an audit state of a workflow, wherein the audit state may comprise such information as audited, unaudited, or the number of people audited, etc. The workflow identification may comprise the predetermined name of the workflow, the name of the shared document in the workflow, etc. There is no restriction here.

Herein, due to the limited display area, etc., the summary of the document in the workflow to-be-viewed is displayed in the workflow state list of the second user. Herein, the summary information of the document to-be-viewed may comprise the name of the document, the type of the document, the avatar and name of the submission of the document, and the label of whether or not the document has been read; and the filtering item supports the filtering of the unread report document to-be-viewed. In the present embodiment, the workflow is a document type workflow, and the workflow state list further comprises: the review state of the document (e.g., read, or unread).

Step 1402. In response to a trigger operation for a workflow by a second user, display content information of the workflow, wherein the content information comprises a document, the document being a co-operable shared document.

In the present embodiment, in response to a trigger operation for a workflow by a second user, for example, in response to a trigger operation for the document summary, the content information of the workflow is displayed, wherein the content information comprises a document, the document being a co-operable shared document.

In the actual implementation process, due to the limited display area, therefore, it is also possible to coordinate the display manner of content information of the function bar and the workflow to ensure the complete display of the relevant content.

For example, when the application page where the workflow state list is located includes, a sidebar as shown in FIG. 15, the default state of the sidebar is folded. By clicking on the “Search” control, in response to a trigger operation for a search control, expand a predetermined navigation function bar in an associated area; and activate an input editing state of the search control.

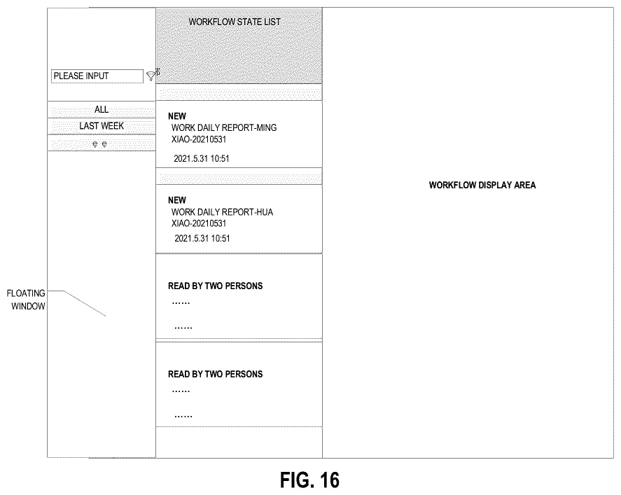

When hovering over the “Search” control, as shown in FIG. 16, the navigation function bar expands in a floating form, covering the existed page, to cover a part of an interface content of the workflow state list.

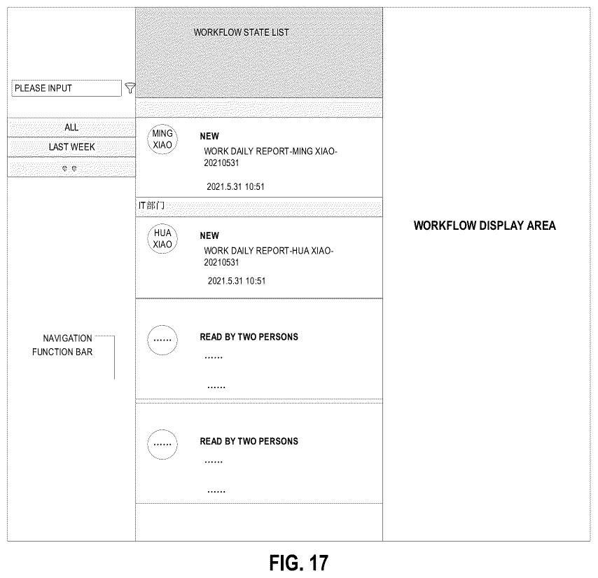

In response to an expanding trigger operation for the navigation function bar, determine a display area corresponding to the navigation function bar, the display area being non-overlapped with an area of the workflow state list, wherein the display area of the content information of the workflow is compressed. For example, as shown in FIG. 17, when triggered on the relevant function control below the side navigation function bar, it squeezes the display area of other areas, etc., thus improving the smoothness of the display.

In one embodiment of the present disclosure, the second user and the first user may also add interaction information to the workflow content, thereby displaying interaction information on the workflow content in a predetermined area.

For example, a scratch comment area may be provided in which interaction information between users is displayed. In the present embodiment, the interaction information may comprise comment information of the second user, a reply information of the first user to the comment information, and the like. The interaction information may be displayed to other second users, etc.

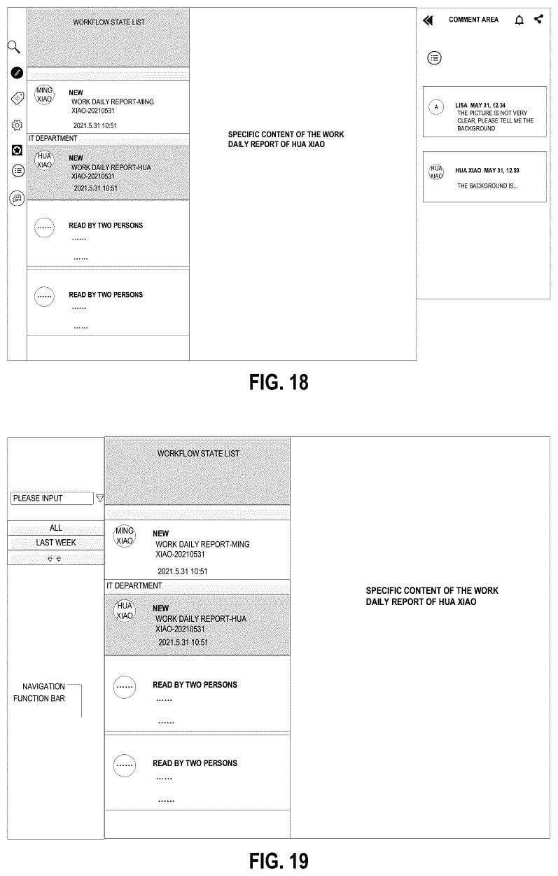

Herein, in order to ensure the complete display of the scratch comment area, t the display area of other functional bars can be squeezed, or the display of the comment area can be controlled to be in the form of a floating window, etc. There is no limitation here. In one embodiment of the present disclosure, as shown in FIG. 18, in response to a trigger operation of a comment area of the content information, unfold a predetermined navigation function bar of an associated area in a coordination way; as shown in FIG. 19, in accordance with a determination that the comment area of the content information is expanded, in response to a trigger operation for the predetermined navigation function bar, fold the comment area of the content information, wherein the comment area of the content information and the navigation function bar are not expanded simultaneously.

In embodiments of the present disclosure, the second user also has the permission to delete the workflow to-be-viewed in the workflow state list, and when it is detected that the second user deleting the corresponding workflow will not delete the source document in the workflow, but the corresponding second user will not see the corresponding workflow.

In summary, the method of information processing provided by embodiments of the present disclosure display a workflow state list; and in response to a trigger operation for a workflow by a second user, display content information of the workflow, wherein the content information comprises a document, the document being a co-operable shared document. Therefore, the second user can view all of the content filled in by the first user based on a shared document without having to manually summarize the received workflow documents. Therefore, document editable in collaboration with a plurality of parties can be applied in the workflow, which improves the automation and efficiency of workflow processing and satisfies the need for a plurality of interaction in workflow processing.

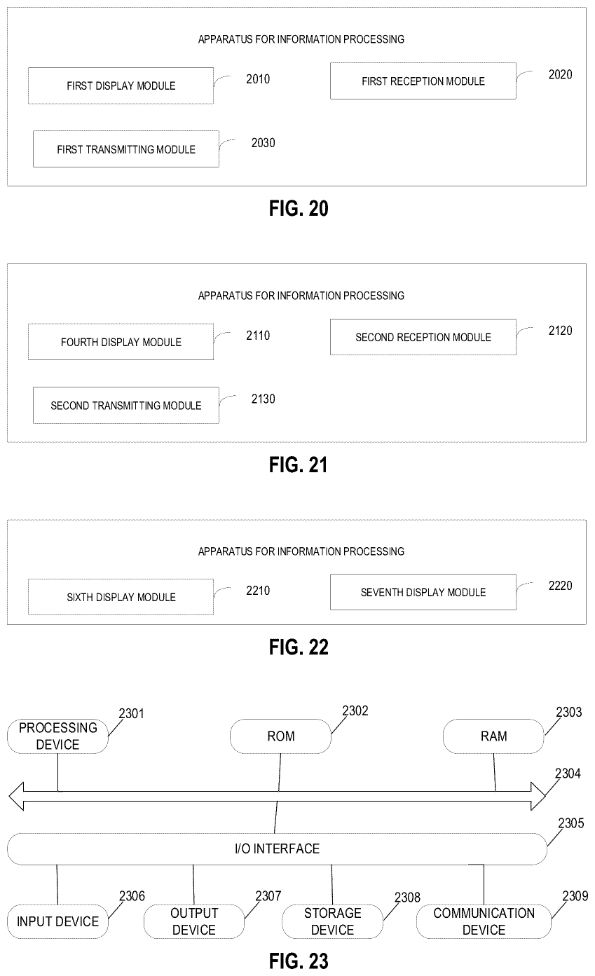

In order to implement the above embodiments, an apparatus for information processing is further provided by the present disclosure. FIG. 20 is a structural schematic diagram of an apparatus for information processing provided by embodiments of the present disclosure. The apparatus can be implemented by software and/or hardware and can generally be integrated in electronic device. As shown in FIG. 20, the apparatus comprises: a first display module 2010, a first reception module 2020, and a first transmitting module 2030, wherein,
the first display module 2010 is configured to, in response to a trigger operation for a workflow type, display an editing page comprising a workflow identification and/or a workflow content, and the workflow content comprising a document, the document being a co-operable shared document;
the first reception module 2020 is configured to receive, on the editing page, an edited content input by a predetermined user; and
the first transmitting module 2030 is configured to, in response to a committing instruction for the workflow type, transmit a corresponding workflow to a first user.

The apparatus for information processing provided by embodiments of the present disclosure may perform the method of information processing provided in any embodiment of the present disclosure, and the method comprises a corresponding functional modules and beneficial effects.

In order to implement the above embodiments, an apparatus for information processing is further provided by the present disclosure. FIG. 21 is a structural schematic diagram of another apparatus for information processing provided by embodiments of the present disclosure. The apparatus can be implemented by software and/or hardware and can generally be integrated in electronic device. As shown in FIG. 21, the apparatus comprises: a fourth display module 2110, a second reception module 2120, and a second transmitting module 2130, wherein,
a fourth display module 2110 is configured to, in response to a trigger operation for a workflow by a first user, display an editing page of the workflow, the editing page comprising a document, the document being a co-operable shared document;
a second reception module 2120 is configured to receive content information input via the editing page; and
a second transmitting module 2130 is configured to, in response to a committing operation for the workflow, transmit a corresponding workflow to a second user.

The apparatus for information processing provided by embodiments of the present disclosure may perform the method of information processing provided in any embodiment of the present disclosure, and the method comprises a corresponding functional modules and beneficial effects.

In order to implement the above embodiments, an apparatus for information processing is further provided by the present disclosure. FIG. 22 is a structural schematic diagram of another apparatus for information processing provided by embodiments of the present disclosure. The apparatus can be implemented by software and/or hardware and can generally be integrated in electronic device. As shown in FIG. 22, the apparatus comprises: a sixth display module 2210, a seventh display module 2220, wherein,
a sixth display module 2210 is configured to display a workflow state list; and
a seventh display module 2220 is configured to, in response to a trigger operation for a workflow by a second user, display content information of the workflow, wherein the content information comprises a document, the document being a co-operable shared document.

The apparatus for information processing provided by embodiments of the present disclosure may perform the method of information processing provided in any embodiment of the present disclosure, and the method comprises a corresponding functional modules and beneficial effects.

In order to implement the above embodiments, the present disclosure further provides a computer program product, comprising a computer program/instructions, the computer program/instructions, when executed by a processor, implementing the method of information processing of the above embodiments.

FIG. 23 is a structural schematic diagram of an electronic device provided by embodiments of the present disclosure.

Referring specifically to FIG. 23 below, it shows a structural schematic diagram of an electronic device 2300 suitable for implementing the embodiments of the present disclosure. The terminal device 2300 in the embodiments of the present disclosure may comprise, but is not limited to a cell phone, a laptop computer, a digital broadcast receiver, a Personal Digital Assistant (PDA), a Portable Android Device (PAD), a Portable Media Player (PMP), an in-vehicle terminal (e.g., an in-vehicle navigation terminal), and the like, and fixed terminals such as a digital television (TV), a desktop computer, and the like. The electronic device illustrated in FIG. 23 is merely an example and should not impose any limitations on the functionality and scope of use of embodiments of the present disclosure.

As shown in FIG. 23, the electronic device 2300 may comprise a processing device (e.g., a central processor, a graphics processor, etc.) 2301, which may perform a variety of appropriate actions and processes based on a program stored in Read-Only Memory (ROM) 2302 or loaded from the storage device 2308 into RAM 2303 to perform various appropriate actions and processes. Various programs and data required for operation of the electronic device 2300 are also stored in the RAM 2303. The processing device 2301, the ROM 2302, and the RAM 2303 are connected to respective other via the bus 2304. An input/output (I/O) interface 2305 is also connected to bus 2304.

Generally, the following devices may be connected to the I/O interface 2305: an input device 2306 comprising, for example, a touch screen, a touch pad, a keyboard, a mouse, a video camera, a microphone, an accelerometer, a gyroscope, and the like; an output device 2307 comprising, for example, a liquid crystal display (LCD), a speaker, a vibrator, and the like; a storage device 2308 comprising, for example, a magnetic tape, a hard disk, and the like; and a communication device 2309. The communication device 2309 may allow the electronic device 2300 to communicate wirelessly or wiredly with other devices to exchange data. Although FIG. 23 illustrates electronic device 2300 with various devices, it should be understood that it is not required to implement or have all of the illustrated devices. More or fewer devices may alternatively be implemented or possessed.

In particular, according to the embodiments of the present disclosure, the process described with reference to the flowchart above may be implemented as a computer software program. For example, embodiments of the present disclosure comprise a computer program product comprising a computer program anchored on a non-transitory computer-readable medium, the computer program comprising program code for executing the method shown in the flowchart. In such embodiments, the computer program may be downloaded and installed from a network via the communication device 2309, or from the storage device 2308, or from the ROM 2302. When the computer program is executed by the processing device 2301, the above functions defined in the method of the embodiments of the present disclosure are performed.

It should be noted that the computer-readable medium described above in the present disclosure may be a computer-readable signal medium or a computer-readable storage medium or any combination thereof. The computer-readable storage medium may, for example, be a system, device, or apparatus or device of electricity, magnetism, light, electromagnetism, infrared, or semiconductors, or an electrical connection of any one or more wires, or a combination of the above. The computer-readable storage medium may comprise: portable computer disk, hard disk, random access memory (RAM), read-only memory (ROM), erasable programmable read-only memory (EPROM, or flash memory), optical fiber, portable compact disk read-only memory (CD-ROM), optical storage device, magnetic storage device, or any suitable combination of the foregoing. For purposes of the present disclosure, a computer-readable storage medium may be any tangible medium that contains or stores a program that may be used by or in combination with an instruction execution system, apparatus, or component. And in the present disclosure, a computer-readable signal medium may comprise a data signal propagated in a baseband or as part of a carrier carrying computer-readable program code. Such propagated data signals may take a variety of forms, comprising electromagnetic signals, optical signals, or any suitable combination of the foregoing. The computer-readable signal medium may also be any computer-readable medium other than a computer-readable storage medium that sends, disseminates, or transmits a program for use by, or in conjunction with, an instruction-executing system, apparatus, or component. The program code contained on the computer-readable medium may be transmitted using any suitable medium, comprising: wire, fiber optic cable, radio frequency (RF), etc., or any suitable combination thereof.

In some implementations, clients, servers may communicate with any currently known or future developed network protocol such as HyperText Transfer Protocol (HTTP) and may be interconnected with any form or medium of digital data communication (e.g., a communications network). Examples of communication networks comprise Local Area Networks (LAN), Wide Area Networks (WAN), Internet (e.g., the Internet), and End-to-End Networks (e.g., ad hoc End-to-End Networks), as well as any currently known or future developed networks.

The computer-readable medium may be included in the above-mentioned electronic device; it may also exist separately and not be assembled into the electronic device.

The computer-readable medium carries one or more programs that, when the one or more programs are executed by the electronic device, enable the electronic device: in response to a trigger operation for a workflow type, displaying an editing page comprising a workflow identification and/or a workflow content, and the workflow content comprising a document, the document being a co-operable shared document; receiving, on the editing page, an edited content input by a predetermined user; and in response to a submission instruction for the workflow type, transmitting a corresponding workflow to a first user; in response to a trigger operation for a workflow by a first user, displaying an editing page of the workflow, the editing page comprising a document, the document being a co-operable shared document; receiving content information input via the editing page; and in response to a submission operation for the workflow, transmitting a corresponding workflow to a second user; then, displaying a workflow state list for a second user; and in response to a trigger operation for a workflow by the second user, displaying content information of the workflow, wherein the content information comprises a document, the document being a co-operable shared document. As a result, the application of collaboration of a plurality of parties in the workflow enhances the degree of automation and efficiency of workflow processing and satisfies the needs of a plurality of parties to interact in workflow processing.

Computer program code for performing the operations of the present disclosure may be written in one or more programming languages, or combinations thereof, including object-oriented programming languages such as Java, Smalltalk, C++, conventional procedural programming languages such as the “C” language, or similar programming languages, or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer over any kind of network, including a LAN or WAN, or it may be connected to an external computer (e.g., via an Internet connection using an Internet service provider).

The flowcharts and block diagrams in the accompanying drawings illustrate the architecture, functionality, and operation of systems, methods, and computer program products that may be implemented in accordance with various embodiments of the present disclosure. At this point, respective box in the flowcharts or block diagrams may represent a module, program segment, or portion of code that contains one or more executable instructions for implementing a specified logical function. It should also be noted that in some implementations that are determined to be substitutions, the functions indicated in the boxes may also occur in a different order than that indicated in the accompanying drawings. For example, two consecutively represented boxes may actually be executed substantially in parallel, and they may sometimes be executed in reverse order, depending on the function involved. It should also be noted that respective of the boxes in the block diagrams and I or flowcharts, as well as combinations of the boxes in the block diagrams and I or flowcharts, may be implemented in a dedicated hardware-based system that performs the specified function or operation, or may be implemented in a combination of dedicated hardware and computer instructions.

Units described as being involved in embodiments of the present disclosure may be implemented by way of software or may be implemented by way of hardware. Wherein the name of a unit does not in some cases constitute a limitation of the unit itself, for example, a first obtaining unit may also be described as “a unit for obtaining at least two Internet Protocol addresses”.

The functions described above herein may be performed, at least in part, by one or more hardware logic components. For example, exemplary types of hardware logic components that may be used include: Field Programmable Gate Array (FPGA), Application Specific Integrated Circuit (ASIC), Application Specific Standard Parts (ASSP), System on Chip (SOC), and System on Chip (SOC). Application Specific Standard Parts (ASSP), System on Chip (SOC), Complex Programmable Logic Device (CPLD) and so on.

In the context of the present disclosure, a machine-readable medium may be a tangible medium that may include or store a program for use by or in conjunction with an instruction execution system, device, or apparatus. The machine-readable medium may be a machine-readable signal medium or a machine-readable storage medium. The machine-readable medium may comprise an electronic, magnetic, optical, electromagnetic, infrared, or semiconductor system, device, or apparatus, or any suitable combination thereof. Machine-readable storage media may comprise an electrical connection based on one or more wires, a portable computer disk, a hard disk, a random-access memory (RAM), a read-only memory (ROM), an erasable programmable read-only memory (EPROM or flash memory), a fiber optic, a compact disk-read-only memory (CD-ROM) for convenience, an optical storage device, a magnetic storage device, or any suitable combination of the foregoing, or any suitable combination thereof.

According to one or more embodiments of the present disclosure, the present disclosure provides a method of information processing, comprising:
in response to a trigger operation for a workflow type, displaying an editing page comprising a workflow identification and/or a workflow content, and the workflow content comprising a document, the document being a co-operable shared document;
receiving, on the editing page, an edited content input by a predetermined user; and
in response to a submission instruction for the workflow type, transmitting a corresponding workflow to a first user.

According to one or more embodiments of the present disclosure, the method of information processing provided in the present disclosure,
the in response to a trigger operation for a workflow type, displaying an editing page comprises:
in response to a trigger operation for a first workflow type, displaying an editable document page; or
in response to a trigger operation for a second workflow type, displaying an editable document page and a further predetermined and non-editable workflow content.

According to one or more embodiments of the present disclosure, the method of information processing provided in the present disclosure further comprises:
in response to a trigger operation for a new document control, displaying a customizable editable document page; or,
in response to a trigger operation for a template document control, displaying an editable template document page.

According to one or more embodiments of the present disclosure, the method of information processing provided in the present disclosure further comprises:
in response to an expanding operation for the document, displaying an entire content of the document on the editing page; and
in response to a folding operation for the document, displaying, on the editing page, indication information representing the content of the document.

According to one or more embodiments of the present disclosure, the method of information processing provided in the present disclosure,
the receiving, on the editing page, an edited content input by a predetermined user comprises:
receiving, on the editing page, guidance information input by a predetermined user for instructing the first user to edit content of the document.

According to one or more embodiments of the present disclosure, the method of information processing provided in the present disclosure,
the receiving, on the editing page, edited content input by a predetermined user comprises:
receiving, on the editing page, a first user identification and a submission time input by a predetermined user; and
in response to a submission instruction for the workflow type, transmitting a corresponding workflow to a first user comprises:
in response to the submission instruction for the workflow type, transmitting the workflow to a corresponding first user based on the submission time and the first user identification.

According to one or more embodiments of the present disclosure, the method of information processing provided in the present disclosure,
the receiving, on the editing page, edited content input by a predetermined user further comprises:
receiving, on the editing page, a reminder time input by the predetermined user; the method further comprising:
transmitting a reminder message of the workflow to the first user based on the reminder time.

According to one or more embodiments of the present disclosure, the present disclosure provides a method of information processing,
the receiving, on the editing page, edited content input by a predetermined user comprises:
receiving, on the editing page, a second user identification input by the predetermined user; the method further comprising:
in response to a submission instruction for the workflow by the first user, transmitting an audit message of the workflow to a second user based on the second user identification.

According to one or more embodiments of the present disclosure, the present disclosure provides a method of information processing further comprising:
in response to the submission instruction for the workflow type, establishing the document in a document space of a user associated with the workflow type; or
in response to the trigger operation for the workflow type, establishing the document in a document space of a user associated with the workflow type.

According to one or more embodiments of the present disclosure, the present disclosure provides a method of information processing further comprising:
in response to an editing operation for the document in the document space, applying a synchronous update of an edited content into the document of the workflow content.

According to one or more embodiments of the present disclosure, the present disclosure provides a method of information processing further comprising:
in response to the submission instruction for the workflow type, creating a user identity corresponding to the workflow type; or
in response to the trigger operation for the workflow type, creating a user identity corresponding to the workflow type.

According to one or more embodiments of the present disclosure, the present disclosure provides a method of information processing, comprising:
in response to a trigger operation for a workflow by a first user, displaying an editing page of the workflow, the editing page comprising a document, the document being a co-operable shared document;
receiving content information input via the editing page; and
in response to a submission operation for the workflow, transmitting a corresponding workflow to a second user.

According to one or more embodiments of the present disclosure, the method of information processing provided in the present disclosure,
the editing page comprises an editable document page; or,
the editing page comprises an editable document page and a further predetermined and non-editable workflow content.

According to one or more embodiments of the present disclosure, the method of information processing provided in the present disclosure,
the editable document page comprises:
a customizable editable document page; or an editable template document page, wherein the first user has an edit permission for the document page.

According to one or more embodiments of the present disclosure, the method of information processing provided in the present disclosure further comprises:
in response to an expanding operation for the document, displaying an entire content of the document on the editing page; and
in response to a folding operation for the document, displaying, on the editing page, indication information representing the content of the document.

According to one or more embodiments of the present disclosure, the method of information processing provided in the present disclosure,
in response to a trigger operation for a workflow by a first user, displaying an editing page of the workflow comprises:
receiving a reminder message of the workflow, wherein the reminder message comprises a link entry of the workflow; and
in response to a trigger operation for the link entry, displaying the editing page of the workflow.

According to one or more embodiments of the present disclosure, the method of information processing provided in the present disclosure, in response to a trigger operation for a workflow by a first user, displaying an editing page of the workflow comprises:
displaying view information of a workflow to-be-processed; and
in response to a trigger operation for the view information, displaying the editing page of the workflow.

According to one or more embodiments of the present disclosure, the method of information processing provided in the present disclosure, the displaying an editing page of the workflow comprises:
displaying, based on a predetermined workflow content, the editing page of the workflow by a management identity user of the workflow.

According to one or more embodiments of the present disclosure, the method of information processing provided in the present disclosure, in response to a trigger operation for a workflow by a first user, the document is created by a user identity corresponding to the workflow.

According to one or more embodiments of the present disclosure, the method of information processing provided in the present disclosure, the document is associated with a document space belonging to a user associated with the workflow.

According to one or more embodiments of the present disclosure, the method of information processing provided in the present disclosure further comprises:
a permission setting of the workflow being the same as a permission setting of an administrator of the first user for the document.

According to one or more embodiments of the present disclosure, the method of information processing provided in the present disclosure, further comprising:
transmitting notification information of the workflow to the first user by a management identity user of the workflow or a first document virtual user.

According to one or more embodiments of the present disclosure, the method of information processing provided in the present disclosure further comprises:
in response to transmitting notification information of the workflow to the first user by the first document virtual user, disabling a second document virtual user from transmitting notification information of the workflow to the first user.

According to one or more embodiments of the present disclosure, the method of information processing provided in the present disclosure further comprises:
transmitting the workflow to the second user by a management identity user of the workflow or a first document virtual user.

According to one or more embodiments of the present disclosure, the present disclosure provides a method of information processing, comprising:
displaying a workflow state list; and
in response to a trigger operation for a workflow by a second user, displaying content information of the workflow, wherein the content information comprises a document, the document being a co-operable shared document.

According to one or more embodiments of the present disclosure, the method of information processing provided in the present disclosure further comprises:
the workflow state list comprises a workflow identification and an audit state of a workflow, and the method further comprising:
in response to a filter trigger operation for an unread workflow, displaying a to-be-processed workflow list.

According to one or more embodiments of the present disclosure, the method of information processing provided in the present disclosure, the workflow state list comprises: a document summary of the document in the workflow.

According to one or more embodiments of the present disclosure, the method of information processing provided in the present disclosure, the workflow is a document type workflow, and the workflow state list further comprises:
a read state or an unread state of the document.

According to one or more embodiments of the present disclosure, the method of information processing provided in the present disclosure further comprises:
in response to a trigger operation for a search control, expanding a predetermined navigation function bar in an associated area; and activating an input editing state of the search control.

According to one or more embodiments of the present disclosure, the method of information processing provided in the present disclosure further comprises:
expanding the navigation function bar in a floating form, to cover a part of an interface content of the workflow state list.

According to one or more embodiments of the present disclosure, the method of information processing provided in the present disclosure further comprises:
in response to an expanding trigger operation for the navigation function bar, determining a display area corresponding to the navigation function bar, the display area being non-overlapped with an area of the workflow state list, wherein the display area of the content information of the workflow is compressed; and
in response to a folding operation of the navigation function bar, ceasing displaying of the navigation function bar, and restoring the workflow state list and the display area of the content information of the workflow.

According to one or more embodiments of the present disclosure, the method of information processing provided in the present disclosure further comprises:
in response to a trigger operation of a comment area of the content information, unfolding a predetermined navigation function bar of an associated area in a coordination way.

According to one or more embodiments of the present disclosure, the method of information processing provided in the present disclosure further comprises:
in accordance with a determination that the comment area of the content information is expanded, in response to a trigger operation for the predetermined navigation function bar, folding the comment area of the content information, wherein the comment area of the content information and the navigation function bar are not expanded simultaneously.

According to one or more embodiments of the present disclosure, the method of information processing provided in the present disclosure further comprises:
in accordance with a determination that the content information comment area is expanded, in response to a trigger operation of the predetermined navigation function bar in a floating form, maintaining the content information comment area as being expanded, wherein the content information comment area and the navigation function bar are expanded simultaneously.

According to one or more embodiments of the present disclosure, the present disclosure provides an apparatus for information processing, comprising:
a first display module configured to, in response to a trigger operation for a workflow type, display an editing page comprising a workflow identification and/or a workflow content, and the workflow content comprising a document, the document being a co-operable shared document;
a first reception module configured to receive, on the editing page, an edited content input by a predetermined user; and
a first transmitting module configured to, in response to a committing instruction for the workflow type, transmit a corresponding workflow to a first user.

According to one or more embodiments of the present disclosure, the present disclosure provides an apparatus for report processing, the first display module, specifically configured to:
in response to a trigger operation for a first workflow type, the workflow content is an editable document page; or,
in response to a trigger operation for a second workflow type, the workflow content comprises: an editable document page and a further predetermined and non-editable workflow content.

According to one or more embodiments of the present disclosure, the apparatus of report processing provided by the present disclosure further comprises:
a second display module configured to, in response to a trigger operation for a new document control, display a customizable editable document page; or,
in response to a trigger operation for a template document control, display an editable template document page.

According to one or more embodiments of the present disclosure, the apparatus for report processing provided by the present disclosure further comprises: a third display module configured to:
in response to an expanding operation for the document, display an entire content of the document on the editing page; and
in response to a folding operation for the document, display, on the editing page, indication information representing the content of the document.

According to one or more embodiments of the present disclosure, the apparatus for report processing provided by the present disclosure, the first reception module is specifically configured to:
receive, on the editing page, guidance information input by a predetermined user for instructing the first user to edit content of the document.

According to one or more embodiments of the present disclosure, the apparatus for report processing provided in the present disclosure, the first reception module is specifically configured to: receive, on the editing page, a first user identification and a submission time input by a predetermined user; and
the first transmitting module is specifically configured to:
in response to the submission instruction for the workflow type, transmit the workflow to a corresponding first user based on the submission time and the first user identification.

According to one or more embodiments of the present disclosure, the apparatus for report processing provided by the present disclosure, the first reception module is specifically configured to: receive, on the editing page, a reminder time input by the predetermined user; the method further comprises:
transmitting a reminder message of the workflow to the first user based on the reminder time.

According to one or more embodiments of the present disclosure, the apparatus for report processing provided by the present disclosure, the first reception module is specifically configured to:
according to one or more embodiments of the present disclosure, the apparatus for report processing provided by the present disclosure, receive, on the editing page, a second user identification input by the predetermined user; the method further comprises:
in response to a submission instruction for the workflow by the first user, transmitting an audit message of the workflow to a second user based on the second user identification.

According to one or more embodiments of the present disclosure, the apparatus for report processing provided by the present disclosure further comprises:
an establishing module configured to, in response to the submission instruction for the workflow type, establish the document in a document space of a user associated with the workflow type; or
in response to the trigger operation for the workflow type, establishing the document in a document space of a user associated with the workflow type.

According to one or more embodiments of the present disclosure, the apparatus for report processing provided by the present disclosure further comprises: an updating module configured to:
in response to an editing operation for the document in the document space, apply a synchronous update of an edited content into the document of the workflow content.

According to one or more embodiments of the present disclosure, the apparatus for report processing provided by the present disclosure further comprises:
a creating module configured to:
in response to the submission instruction for the workflow type, create a user identity corresponding to the workflow type; or
in response to the trigger operation for the workflow type, create a user identity corresponding to the workflow type.

According to one or more embodiments of the present disclosure, the present disclosure provides an apparatus for information processing, comprising:
a fourth display module configured to, in response to a trigger operation for a workflow by a first user, display an editing page of the workflow, the editing page comprising a document, the document being a co-operable shared document;
a second reception module configured to receive content information input via the editing page; and
a second transmitting module configured to, in response to a committing operation for the workflow, transmit a corresponding workflow to a second user.

According to one or more embodiments of the present disclosure, the apparatus for report processing provided in the present disclosure, the editing page comprises an editable document page; or,
the editing page comprises an editable document page and a further predetermined and non-editable workflow content.

According to one or more embodiments of the present disclosure, the apparatus for report processing provided by the present disclosure, the editable document page comprises:
a customizable editable document page; or an editable template document page, wherein the first user has an edit permission for the document page.

According to one or more embodiments of the present disclosure, the apparatus for report processing provided by the present disclosure further comprises: a fifth display module configured to:
in response to an expanding operation for the document, display an entire content of the document on the editing page; and
in response to a folding operation for the document, display, on the editing page, indication information representing the content of the document.

According to one or more embodiments of the present disclosure, the apparatus for report processing provided by the present disclosure, the fourth display module is specifically configured to:
receive a reminder message of the workflow, wherein the reminder message comprises a link entry of the workflow; and
in response to a trigger operation for the link entry, display the editing page of the workflow.

According to one or more embodiments of the present disclosure, the apparatus for report processing provided by the present disclosure,
the fourth display module is specifically configured to: display view information of a workflow to-be-processed; and
in response to a trigger operation for the view information, display the editing page of the workflow.

According to one or more embodiments of the present disclosure, the apparatus for report processing provided by the present disclosure, the fourth display module is specifically configured to:
display, based on a predetermined workflow content, the editing page of the workflow by a management identity user of the workflow.

According to one or more embodiments of the present disclosure, the apparatus for report processing provided by the present disclosure further comprises: a document creating module configured to:
in response to a trigger operation for a workflow by a first user, create the document by a user identity corresponding to the workflow.

According to one or more embodiments of the present disclosure, the apparatus for report processing provided by the present disclosure, the document is associated with a document space belonging to a user associated with the workflow.

According to one or more embodiments of the present disclosure, the apparatus for report processing provided by the present disclosure, a permission setting of the workflow is the same as a permission setting of an administrator of the first user for the document.

According to one or more embodiments of the present disclosure, the apparatus for report processing provided by the present disclosure further comprises:
a third transmitting module configured to transmit notification information of the workflow to the first user by a management identity user of the workflow or a first document virtual user.

According to one or more embodiments of the present disclosure, the apparatus for report processing provided in the present disclosure, the third transmitting module is further configured to, in response to transmitting notification information of the workflow to the first user by the first document virtual user, disable a second document virtual user from transmitting notification information of the workflow to the first user.

According to one or more embodiments of the present disclosure, the apparatus for report processing provided by the present disclosure further comprises:
a fourth transmitting module configured to transmit the workflow to the second user by a management identity user of the workflow or a first document virtual user.

According to one or more embodiments of the present disclosure, the present disclosure provides an apparatus for information processing comprises:
a sixth display module configured to displaying a workflow state list; and
a seventh display module configured to, in response to a trigger operation for a workflow by a second user, display content information of the workflow, wherein the content information comprises a document, the document being a co-operable shared document.

According to one or more embodiments of the present disclosure, the apparatus for report processing provided by the present disclosure,
according to one or more embodiments of the present disclosure, the apparatus for report processing provided by the present disclosure, the workflow state list comprises a workflow identification and an audit state of a workflow, and further comprises:
an eighth display module configured to, in response to a filter trigger operation for an unread workflow, display a to-be-processed workflow list.

According to one or more embodiments of the present disclosure, the apparatus for report processing provided by the present disclosure, the workflow state list comprises: a document summary of the document in the workflow.

According to one or more embodiments of the present disclosure, the present disclosure provides an apparatus for report processing, the workflow is a document type workflow, and the workflow state list further comprises:
a read state or an unread state of the document.

According to one or more embodiments of the present disclosure, the apparatus for report processing provided by the present disclosure further comprises: an activation module configured to:
in response to a trigger operation for a search control, expand a predetermined navigation function bar in an associated area; and
activate an input editing state of the search control.

According to one or more embodiments of the present disclosure, the apparatus for report processing provided by the present disclosure further comprises: expanding the navigation function bar in a floating form, to cover a part of an interface content of the workflow state list.

According to one or more embodiments of the present disclosure, the apparatus for report processing provided in the present disclosure further comprises: a determination module configured to, in response to an expanding trigger operation for the navigation function bar, determine a display area corresponding to the navigation function bar, the display area being non-overlapped with an area of the workflow state list, wherein the display area of the content information of the workflow is compressed; and;
a recovery module configured to, in response to a folding operation of the navigation function bar, cease displaying of the navigation function bar, and restoring the workflow state list and the display area of the content information of the workflow.

According to one or more embodiments of the present disclosure, the apparatus for report processing provided by the present disclosure further comprises:
a coordination module configured to respond to, in response to a trigger operation of a comment area of the content information, unfold a predetermined navigation function bar of an associated area in a coordination way.

According to one or more embodiments of the present disclosure, the apparatus for report processing provided in the present disclosure, further comprises: a first comment area processing module configured to, in accordance with a determination that the comment area of the content information is expanded, in response to a trigger operation for the predetermined navigation function bar, fold the comment area of the content information, wherein the comment area of the content information and the navigation function bar are not expanded simultaneously.

According to one or more embodiments of the present disclosure, the apparatus for report processing provided by the present disclosure further comprising: a second comment processing module configured to:
in accordance with a determination that the content information comment area is expanded, in response to a trigger operation of the predetermined navigation function bar in a floating form, maintain the content information comment area as being expanded, wherein the content information comment area and the navigation function bar are expanded simultaneously.

According to one or more embodiments of the present disclosure, the present disclosure provides an electronic device comprising:
a processor; and
a memory storing instructions executable for the processor;
the processor configured to read the executable instructions from the memory and execute the instructions to implement any of the method of information processing as described in the disclosure.

According to one or more embodiments of the present disclosure, the present disclosure provides a computer-readable storage medium, characterized in that the medium stores a computer program, the computer program, when executed by a computer device, causing the computer device to perform any of the method of information processing as described in the disclosure.

The above description is only the preferred embodiment of the present disclosure and the explanation of the technical principles used. Those skilled in the art should understand that the scope of the disclosure involved in the present disclosure is not limited to the technical solutions formed by specific combinations of the above technical features but should also cover other technical solutions formed by any combination of the above technical features or their equivalent features without departing from the above disclosure concept. For example, the technical solutions formed by replacing the above features with (but not limited to) technical features with similar functions disclosed in the present disclosure.

Furthermore, although a plurality of operations is depicted in a particular order, this should not be construed as requiring that the operations be performed in the particular order shown or in sequential order of performance. In certain environments, multitasking and parallel processing may be advantageous. Similarly, while a plurality of implementation details is included in the above discussion, these should not be construed as limiting the scope of the present disclosure. Some of the features described in the context of separate embodiments may also be implemented in combination in a single embodiment. Conversely, a plurality of features described in the context of a single embodiment may also be implemented in a plurality of embodiments, either individually or in any suitable sub-combination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims.

1. A method of information processing, comprising:
in response to a trigger operation for a workflow type, displaying an editing page comprising a workflow identification and/or a workflow content, and the workflow content comprising a document, the document being a co-operable shared document;
receiving, on the editing page, an edited content input by a predetermined user; and
in response to a submission instruction for the workflow type, transmitting a corresponding workflow to a first user.

2. The method of claim 1, wherein the in response to a trigger operation for a workflow type, displaying an editing page comprises:
in response to a trigger operation for a first workflow type, displaying an editable document page; or
in response to a trigger operation for a second workflow type, displaying an editable document page and a further predetermined and non-editable workflow content.

3. The method of claim 1, further comprising:
in response to a trigger operation for a new document control, displaying a customizable editable document page; or,
in response to a trigger operation for a template document control, displaying an editable template document page.

4. The method of claim 1, further comprising:
in response to an expanding operation for the document, displaying an entire content of the document on the editing page; and
in response to a folding operation for the document, displaying, on the editing page, indication information representing the content of the document.

5. The method of claim 1, wherein the receiving, on the editing page, an edited content input by a predetermined user comprises:
receiving, on the editing page, guidance information input by a predetermined user for instructing the first user to edit content of the document.

6. The method of claim 1, wherein the receiving, on the editing page, edited content input by a predetermined user comprises:
receiving, on the editing page, a first user identification and a submission time input by a predetermined user; and
wherein the in response to a submission instruction for the workflow type, transmitting a corresponding workflow to a first user comprises:
in response to the submission instruction for the workflow type, transmitting the workflow to a corresponding first user based on the submission time and the first user identification.

7. The method of claim 6, wherein the receiving, on the editing page, edited content input by a predetermined user further comprises:
receiving, on the editing page, a reminder time input by the predetermined user; the method further comprising:
transmitting a reminder message of the workflow to the first user based on the reminder time.

8. The method of claim 1, wherein the receiving, on the editing page, edited content input by a predetermined user comprises:
receiving, on the editing page, a second user identification input by the predetermined user; the method further comprising:
in response to a submission instruction for the workflow by the first user, transmitting an audit message of the workflow to a second user based on the second user identification.

9. The method of claim 1, further comprising:
in response to the submission instruction for the workflow type, establishing the document in a document space of a user associated with the workflow type; or
in response to the trigger operation for the workflow type, establishing the document in a document space of a user associated with the workflow type.

10. The method of claim 9, further comprising:
in response to an editing operation for the document in the document space, applying a synchronous update of an edited content into the document of the workflow content.

11. The method of claim 1, further comprising:
in response to the submission instruction for the workflow type, creating a user identity corresponding to the workflow type; or
in response to the trigger operation for the workflow type, creating a user identity corresponding to the workflow type.

12-37. (canceled)

38. An electronic device, comprising:
a processor; and
a memory storing instructions executable for the processor;
the processor configured to read the executable instructions from the memory and execute the instructions to implement the method of information processing comprising:
in response to a trigger operation for a workflow type, displaying an editing page comprising a workflow identification and/or a workflow content, and the workflow content comprising a document, the document being a co-operable shared document;
receiving, on the editing page, an edited content input by a predetermined user; and
in response to a submission instruction for the workflow type, transmitting a corresponding workflow to a first user.

39. (canceled)

40. The electronic device of claim 38, wherein the in response to a trigger operation for a workflow type, displaying an editing page comprises:
in response to a trigger operation for a first workflow type, displaying an editable document page; or
in response to a trigger operation for a second workflow type, displaying an editable document page and a further predetermined and non-editable workflow content.

41. The electronic device of claim 38, wherein the method further comprises:
in response to a trigger operation for a new document control, displaying a customizable editable document page; or,
in response to a trigger operation for a template document control, displaying an editable template document page.

42. The electronic device of claim 38, wherein the method further comprises:
in response to an expanding operation for the document, displaying an entire content of the document on the editing page; and
in response to a folding operation for the document, displaying, on the editing page, indication information representing the content of the document.

43. The electronic device of claim 38, wherein the receiving, on the editing page, an edited content input by a predetermined user comprises:
receiving, on the editing page, guidance information input by a predetermined user for instructing the first user to edit content of the document.

44. The electronic device of claim 38, wherein the receiving, on the editing page, edited content input by a predetermined user comprises:
receiving, on the editing page, a first user identification and a submission time input by a predetermined user; and
wherein the in response to a submission instruction for the workflow type, transmitting a corresponding workflow to a first user comprises:
in response to the submission instruction for the workflow type, transmitting the workflow to a corresponding first user based on the submission time and the first user identification.

45. The electronic device of claim 44, wherein the receiving, on the editing page, edited content input by a predetermined user further comprises:
receiving, on the editing page, a reminder time input by the predetermined user; the method further comprising:
transmitting a reminder message of the workflow to the first user based on the reminder time.

46. The electronic device of claim 38, wherein the receiving, on the editing page, edited content input by a predetermined user comprises:
receiving, on the editing page, a second user identification input by the predetermined user; the method further comprising:
in response to a submission instruction for the workflow by the first user, transmitting an audit message of the workflow to a second user based on the second user identification.

47. A non-transitory computer-readable storage medium, wherein the medium stores a computer program, the computer program, when executed by a computer device, causing the computer device to perform the method of information processing comprising:
in response to a trigger operation for a workflow type, displaying an editing page comprising a workflow identification and/or a workflow content, and the workflow content comprising a document, the document being a co-operable shared document;
receiving, on the editing page, an edited content input by a predetermined user; and
in response to a submission instruction for the workflow type, transmitting a corresponding workflow to a first user.
